(19) United States
(12) Patent Application Publication
(10) Pub. No.: US 2012/0284118 A1
(43) Pub. Date: Nov. 8, 2012

(54) USING COLLECTIVE DATA FOR TARGETING OF ADVERTISEMENTS

(75) Inventors: VICTOR CARL MAMICH, JR., Bellevue, WA (US); SAMEER ABROL, Bellevue, WA (US)

(73) Assignee: MICROSOFT CORPORATION, Redmond, WA (US)

(21) Appl. No.: 13/100,465

(22) Filed: May 4, 2011

(51) Int. Cl. G06Q 30/00

(52) U.S. Cl. 705/14.52; 705/14.58

(57) ABSTRACT

A method, system, and medium are provided for targeting advertisements to users of a search engine based on collective data and the geographic location of the user. Collective data comprising any non-user-specific data, such as public and/or private statistical data for a population of users and for a geographic area is employed to identify geographic areas to which to provide advertisements. Advertisers select target criteria that indicate characteristics of a population of users or of a geographic area that are desirable for provision of the advertisement. A geographic granularity or geographic subdivision is specified. Geographic areas of the specified granularity are identified that are associated with collective data that meets the target criteria. As such, the advertisement is provided for presentation to a user that executes a search query from an identified geographic area.

### SUMMARY

Embodiments of the invention are defined by the claims below, not this summary. A high-level overview of various aspects of the invention are provided here for that reason, to provide an overview of the disclosure, and to introduce a selection of concepts that are further described in the detailed-description section below. This summary is not intended to identify key features or essential features of the claimed subject matter, nor is it intended to be used as an aid in isolation to determine the scope of the claimed subject matter.

In brief and at a high level, this disclosure describes, among other things, ways to provide advertisement targeting using collective data, e.g. non-user-specific data. An advertiser creates an advertisement campaign that includes an advertisement. A number of target criteria are selected that indicate characteristics of a population of users and/or of a geographic area that are desirable for provision of the advertisement. A geographic granularity is also selected. The geographic granularity describes a subdivision of the world geography by which to analyze the collective data for meeting the target criteria. Geographic areas that are associated with collective data meeting the target criteria are identified based on the selected geographic granularity. As such, the advertisement may be provided for presentation to a user that is identified as being within one of the identified geographic areas.

### DESCRIPTION OF THE DRAWINGS

Illustrative embodiments of the invention are described in detail below with reference to the attached drawing figures, and wherein:

FIG. 1 is a block diagram of an exemplary computing device suitable for use in accordance with an embodiment of the invention;

FIG. 2 is a block diagram of an exemplary operating environment suitable for use in accordance with an embodiment of the invention;

FIG. 3 is a graphical illustration of a user interface provided to an advertiser for configuring an advertisement campaign in accordance with an embodiment of the invention;

FIG. 4 is a flow diagram depicting a method for targeting advertisements to a user of a search engine based on collective data in accordance with an embodiment of the invention;

FIG. 4A is a flow diagram depicting additional steps for the method depicted in FIG. 3 in accordance with an embodiment of the invention;

FIG. 5 is a block diagram depicting a system for targeting advertisements presented in a search engine results page based on collective data and a user's location in accordance with an embodiment of the invention; and

FIG. 6 is a flow diagram depicting a method for targeting advertisements presented in a search engine results page based on collective data and a user's identified location in accordance with an embodiment of the invention.

### DETAILED DESCRIPTION

The subject matter of select embodiments of the invention is described with specificity herein to meet statutory requirements. But the description itself is not intended to necessarily limit the scope of claims. Rather, the claimed subject matter might be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described.

Embodiments of the invention include methods, systems, and computer-readable media for targeting advertisements to search engine users based on collective data for a user population and/or geographic area and based on an identified location of a user executing a search query. Thus, in embodiments of the invention, advertisements are targeted to users based on characteristics of users in a geographic area as a whole and/or on characteristics of the geographic area in which they are located. As such, users for which no user-specific data is available may be targeted. And advertisers are enabled to target users without encroaching on any user privacy concerns that might arise through the collection and use of user-specific data.

Collective data includes any non-user-specific data available for a population of people. In an embodiment, collective data includes census data, statistical data, demographic data, commercial data, or the like. For example, collective data might include statistical census data indicating a percentage of people in a population that are employed, are in the upper middle class, and that are over age 65. Collective data also includes data associated with a given geographic area such as that associated with weather, politics, infrastructure, or the like. Collective data includes historical and current data as well as data updated in real-time, periodically, or upon request. For example, collective data for a geographic area might include current or forecasted weather conditions, changes in market indices, or current events.

Collective data does not include user-specific data such as, for example, and not limitation, a particular user's age, gender, marital status, income level, occupation, or the like. User-specific data is descriptive of a particular user individually—not a population of people as a whole. User-specific data is often obtained through user submission during an account creation, tracking of the user's habits, purchases, or other activities on one or more websites, web services, or the like.

In an embodiment of the invention, computer-readable media having computer-executable instructions embodied thereon that, when executed, perform a method for targeting advertisements to a user of a search engine based on collective data is described. A selection of target criteria for an advertisement is received. A selection of a geographic granularity for advertisement targeting is also received. A computing device having a processor determines a geographic area in which collective data associated with a population of users and/or the geographic area correlate with the target criteria. The geographic area is identified with respect to the geographic granularity. A bid is received for an amount to be paid for providing the advertisement for presentation to a user of a search engine when the user is located within the geographic area.

In another embodiment, a system for targeting advertisements presented in a search engine results page based on collective data and a user's location is described. The system includes an advertisement-campaign-configuration component, a geographical-area-identification component, and a bid receiving component. The advertisement-campaign-configuration component is configured to receive a selection of target criteria to be associated with an advertisement and to receive a selection of a level of geographic granularity upon which targeting of the advertisement is to be based. The target criteria indicate characteristics of a user population, a geographic location, or data associated with the user population or geographic location. The geographic-area-identification component is executed by a computing device having a processor and is configured to identify one or more geographic areas for which collective data correlates with the target criteria. The geographic area is identified with respect to the geographic granularity. The collective data describes characteristics of, or associated with, a user population in the geographic area and the geographic area and includes only non-user-specific data. The bid receiving-component is configured to receive a bid indicating an amount to be paid for providing the advertisement for presentation to a user that is identified as being located within the one or more geographic areas.

In another embodiment, a method for targeting advertisements presented in a search engine results page based on collective data and a user's identified location is described. An advertiser selects via a user interface presented by a first computing device having a processor, target criteria to be associated with an advertisement and a geographic granularity for targeting of the advertisement. Keywords associated with the advertisement are also provided. An indication of a geographic area associated with collective data that meets the target criteria is received. The geographic area is identified by a second computing device having a processor based on collective characteristics of the geographic area and a population of users in the geographical area. The collective characteristics include only non-user-specific information and the geographic area is indicated at the selected geographic granularity level. An amount to be paid for providing the advertisement for presentation to a user that is located within the geographic area and that provides at least one of the keywords to a search engine is received. The advertisement is presented on a search engine results page.

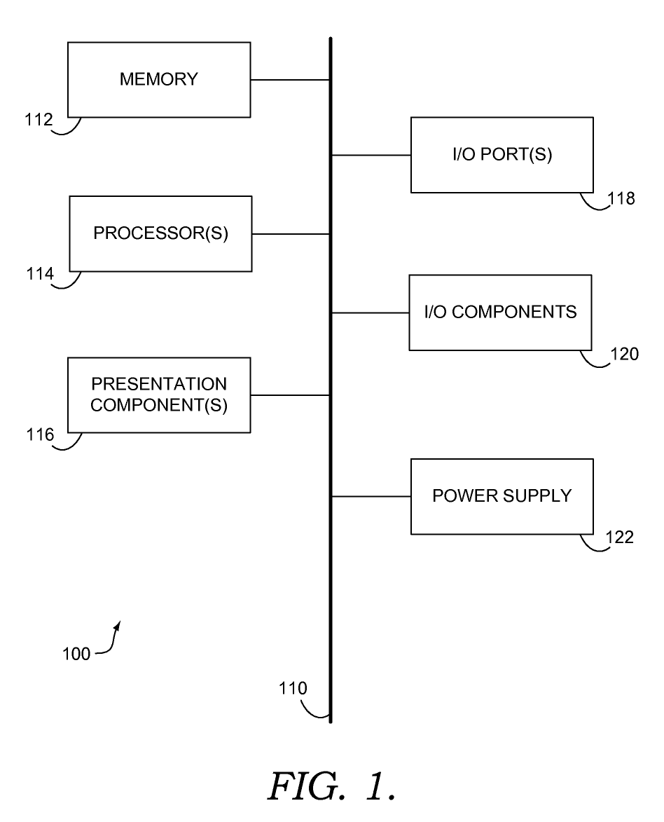

Referring initially to FIG. 1 in particular, an exemplary computing device for implementing embodiments of the present invention is shown and designated generally as a computing device 100. The computing device 100 is but one example of a suitable computing environment and is not intended to suggest any limitation as to the scope of use or functionality of invention embodiments. Neither should the computing device 100 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the invention may be practiced in a variety of system configurations, including hand-held devices, consumer electronics, general-purpose computers, more specialty computing devices, etc. Embodiments of the invention may also be practiced in distributed computing environments where tasks are performed by remote-processing devices that are linked through a communications network.

With reference to FIG. 1, the computing device 100 includes a bus 110 that directly or indirectly couples the following devices: a memory 112, one or more processors 114, one or more presentation components 116, one or more input/output ports 118, one or more input/output components 120, and an illustrative power supply 122. The bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. It is recognized that such is the nature of the art, and reiterate that the diagram of FIG. 1 is merely illustrative of an exemplary computing device that can be used in connection with one or more embodiments of the invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. By way of example, and not limitation, computer-readable media may comprise Random-Access Memory (RAM); Read-Only Memory (ROM); Electronically Erasable Programmable Read-Only Memory (EEPROM); flash memory or other memory technologies; compact disc read-only memory (CD-ROM), digital versatile disks (DVD) or other optical or holographic media; magnetic cassettes, magnetic tape, magnetic disk storage or other magnetic storage devices or any other non-transitory computer-readable medium that can be used to encode desired information and be accessed by computing device 100. Computer-readable media and computer-storage media are not inclusive of carrier waves, signals, and other forms of transitory media.

The memory 112 includes computer-storage media in the form of volatile and/or nonvolatile memory. The memory may be removable, nonremovable, or a combination thereof. Exemplary hardware devices include solid-state memory, hard drives, optical-disc drives, etc. The computing device 100 includes one or more processors that read data from various entities such as the memory 112 or I/O components 120. The presentation component(s) 116 present data indications to a user or other device. Exemplary presentation components include a display device, a speaker, a printing component, a vibrating component, etc.

The I/O ports 118 allow the computing device 100 to be logically coupled to other devices including the I/O components 120, some of which may be built in. Illustrative components include a microphone, joystick, game pad, satellite dish, scanner, printer, wireless device, etc.

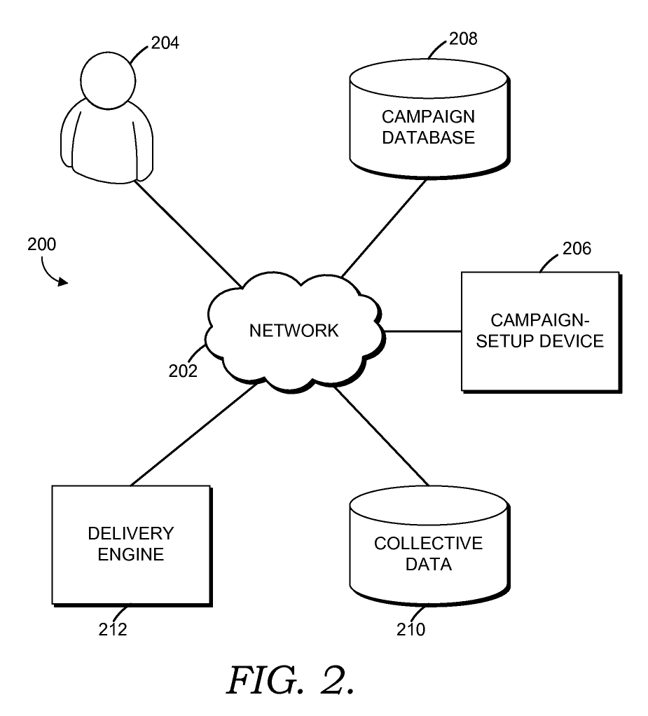

Referring now to FIG. 2, an exemplary computing environment 200 suitable for use in accordance with an embodiment of the invention is described. The environment 200 includes a network 202, an advertiser 204, a campaign-setup device 206, a campaign-data storage 208, a collective-data storage 210, and a delivery engine 212. The environment 200 depicted in FIG. 2 is only one exemplary computing environment, of which there may be many, suitable for implementing embodiments of the invention. Further, the components depicted in FIG. 2 are depicted singularly for clarity and are provided with names for reference, but one of ordinary skill in the art will recognize that a plurality of similar components may be used in application and that the nomenclature for the components may change without distracting from the functions described herein with respect to implementation of embodiments of the invention. Further, the nomenclature applied to a particular component in the environment 200 may change with respect to functions being performed thereby.

The network 202 includes any computer network such as, for example and not limitation, the Internet, an intranet, private and public local networks, and wireless data or telephone networks. The advertiser 204 includes any person, company, agency, or other party that wishes to engage in provision of advertisements to users of a search engine. It is understood that the advertiser 204 communicates with the network 202 and other components described herein via one or more computing devices; these devices are not shown or described further herein to avoid obscuring description of embodiments of the invention.

The advertisements include any form of electronic media such as text, images, videos, audio files, or the like that can be presented by an electronic device. The advertisements are presented to users by any computing device (not shown), such as the computing device 100, including personal computers, laptops, mobile devices, and personal digital assistants, among others.

The campaign-setup device 206 is any computing device, such as the computing device 100, that is configured to receive information regarding advertisements from advertisers 204 and to provide advertisements to the delivery engine 212 for presentation to a user. The information received from the advertiser 204 includes one or more of the advertisement itself, details of an advertisement campaign such as a campaign name, campaign structure, or budget for the campaign, target criteria, keywords, and a geographic granularity designation for the campaign.

The advertisement is provided in any electronic form useable for providing impressions of the advertisement to users. An advertisement campaign may be structured and set up in any way desired; a campaign can be created hierarchically having a number of individual advertisements organized under a single campaign or a campaign might only have a single advertisement. Further, the campaign can be structured such that details of the campaign apply to all advertisements in the campaign or each individual advertisement in the campaign might have its own specific details for targeting, budget, and the like.

Target criteria comprise any characteristic determinable from collective data that is useable to identify a geographic area as a target for provision of an advertisement. The target criteria might also include a value or range of values of the collective data associated with a target criterion. For example, and not limitation, target criteria might include criteria based on one or more of personal characteristics, salary, expenditures, occupations, education, housing, and commuting habits of a population of people in an area as well as criteria based on industry, crime, and weather statistics for an area. These exemplary target criteria are further described below.

Personal characteristics might include data for a population including, for example, the median age, total population, and percentages of males/females, people in various age ranges, marital status, family groups, and ethnicities represented. Target criteria based on salary, expenditures, and occupations might include a percentage of employed/unemployed, household net worth, occupations, income statistics, average expenditures for household costs, apparel, contributions, education, entertainment, food, furnishings, gifts, healthcare, household operations, misc., personal care, shelter, tobacco, transportation, and utilities. Educational criteria might include a current or completed level of education and housing data might include percentages of housing that is vacant, owned/occupied, or rented as well as average housing sizes, ages of structures, and household demographics. Commuting habits include statistics on for example, average number of occupants of vehicles, percentages of people that carpool or use public transportation, types of vehicles driven, traffic statistics, and average commuting time.

Similarly, target criteria based on industry statistics may include types of industries available in an area and percentages of people that work in an industry. Crime statistics for numbers of crimes, personal crimes, or property crimes committed, among others, might also be employed. Weather patterns including natural disaster data can also be used. For example, average high/low temperatures, almanac data for seasonal changes, average rainfall/snowfall amounts, and severe weather indices might be used.

Keywords provided by the advertiser 204 include any words, phrases, symbols, or portions thereof that can be entered by a search-engine user for execution of a search query. In an embodiment, a search engine is configured to accept and execute an image search based on a provided image and the keywords comprise images, image features, or image characterizations.

The advertiser 204 also provides a geographic granularity designation. Geographic granularity refers to a level of subdivision of the world geography. For example, the world geography can be subdivided based on hemispheres, continents, countries, regions, states, counties, parishes, townships, cities, zip codes, census tracts, or any other desired subdivision. The designation indicates a level of geographic granularity or subdivision by which collective data is to be calculated, sorted, organized, or otherwise employed to determine whether a target criteria is met.

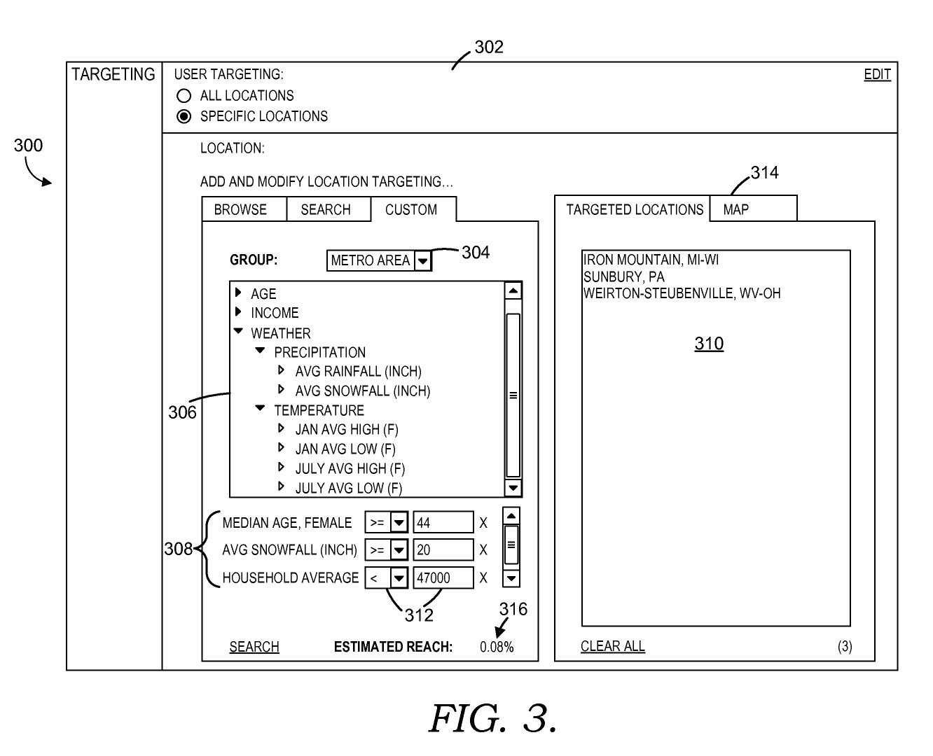

With continued reference to FIG. 2, the campaign-setup device 206 might also provide a user interface for display to the advertiser 204 by which the advertiser 204 can provide the advertisement information and design an advertisement campaign. With additional reference to FIG. 3, an exemplary user interface 300 that is provided to an advertiser 204 for configuring an advertisement campaign is depicted. It is to be understood that the user interface 300 is but one exemplary user interface, of which there are many that are suitable for use in accordance with embodiments of the invention without departing from the scope described herein. The user interface 300 is not intended to limit or restrict embodiments of the invention to any particular user interface or features presented thereby.

The user interface 300 includes a geographic-targeting-designation pane 302 by which an advertiser 204 selects whether to have the option of designating particular identified geographic areas for advertisement targeting or to apply selections made via the user interface 300 across all geographic areas generally, as is further described below. The user interface 300 also includes a geographic-granularity-selection field 304, a target-criteria-selection field 306, a selected-target-criteria listing 308, and an identified-geographic-areas field 310.

The geographic-granularity-selection field 304 provides a drop-down list of available geographic subdivisions by which the advertiser 204 can select for advertisement targeting. The target-criteria-selection field 306 displays a listing of a number of available target criteria that can be employed for advertisement targeting. The selected-target-criteria listing 308 depicts target criteria that an advertiser 204 has selected for targeting of an advertisement as well as range fields 312 in which the advertiser 204 provides an indication of a range or value of collective data for a geographic area that satisfies an associated selected target criteria.

Further, the identified-geographic-areas field 310 provides an indication of geographic areas that have been identified as having associated collective data that meets the selected target criteria. In an embodiment, the field 310 provides a selectable list of geographic areas with collective data meeting the target criteria such that the advertiser 204 can further narrow advertisement targeting to the selected geographic areas. A map tab 314 is also included to provide an advertiser 204 with a graphical indication on a map of the geographic areas indicated in the field 310.

Returning now to FIG. 2, the campaign-data storage 208 includes any one or more computer storage devices, computer memories, databases, memory structures, or the like. The campaign-data storage 208 is configured to store advertisements, and advertisement campaign information including target criteria, keywords, and geographic granularity designations received from an advertiser 204 by the campaign-setup device 206. The campaign-data storage 208 is communicatively coupled to the campaign-setup device 206 via the network 202 or is directly coupled to or a component of the campaign-setup device 206.

The collective-data storage 210 includes any one or more computer storage devices, computer memories, databases, memory structures, or the like. The collective-data storage 210 and the collective data stored thereby may be public or private. The collective data stored by the collective-data storage 210 is provided by or obtained from government organizations, public entities, private companies, or any other available source.

The delivery engine 212 includes any one or more computing devices, such as the exemplary computing-device 100, and is configured to retrieve or receive advertisements from one or more of the campaign-setup device 206 and the campaign-data storage 208 for provision to a search engine results page. The delivery engine 212 is configured to determine that a search request is received from a user located within a geographic area associated with an advertisement. Or the delivery engine 212 provides a user's location to the campaign-setup device 206 for determination of the user's location as being in or outside of the geographic area. The delivery engine 212 may provide advertisements directly to a user's computing device for presentation in a search results page or the advertisements may be provided to a subsequent device charged with providing the search engine results page, as is known in the art.

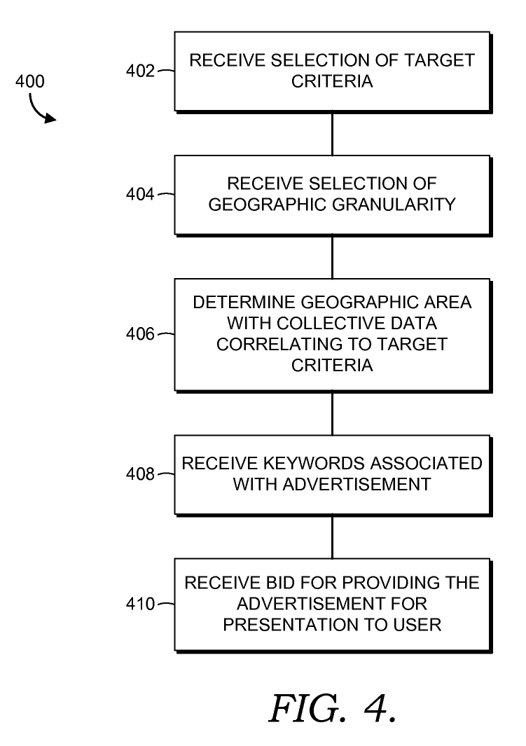

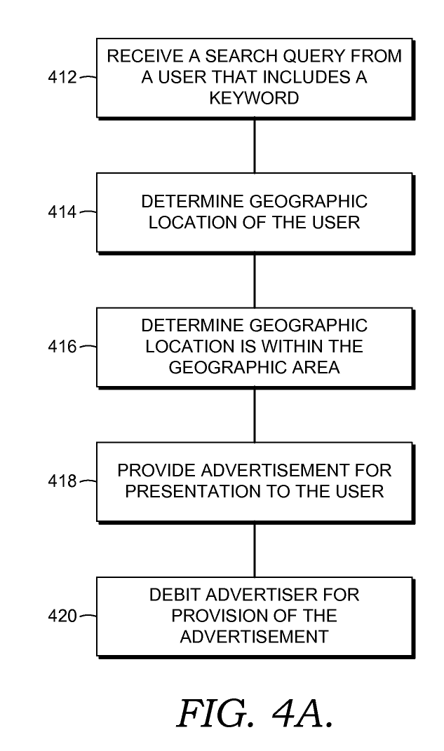

Referring now to FIG. 4, a method 400 for targeting advertisements to a user of a search engine based on collective data is described in accordance with an embodiment of the invention. In an embodiment, an advertiser initially sets up an account with a search engine provider to register the advertiser's general information, billing details, and the like. The advertiser might also initialize or setup an advertisement campaign by supplying a campaign name, campaign budget, and a number of advertisements or ad units to be employed under the campaign, among other information. The advertiser also indicates whether advertisement targeting criteria, bidding, and geographic targeting is to apply to the campaign generally or to individual advertisements separately. In an embodiment, the advertiser also uploads the advertisement content to a server or data storage, such as the client-setup device 206 and campaign-data storage 208.

Accordingly, as indicated at step 402 a selection of target criteria is received from an advertiser for either an individual advertisement, a group of advertisements, or for an advertisement campaign generally as selected by the advertiser. In an embodiment, the target criteria are selected via a user interface, such as the user interface 300. As described above, the target criteria include any characteristic determinable from collective data that is useable to identify a geographic area as a target for provision of an advertisement. For example, as depicted in FIG. 3, an advertiser might select to have an advertisement directed to a population of users that have a median age of women greater than or equal to 44 years old and a household average income less than $47,000 per year. The advertiser may also select to target geographic areas that have an average snowfall greater than or equal to 20 inches.

At a step 404, a selection of a geographic granularity is also received from the advertiser. As described previously, the geographic granularity indicates a subdivision of the world geography based upon which to examine collective data for meeting target criteria. For example, an advertiser can select to use a geographic granularity level of “countries” to target geographic areas based on a large scale or the advertiser can select subdivisions as small as a zip code area to target smaller populations. In an embodiment, selecting a smaller subdivision or a finer geographic granularity increases the specificity of the targeting and may increase the likelihood of reaching the intended recipients of the advertisements. For instance, the collective data for smaller populations likely represents those people in the population more specifically than would collective data for a very large population. Continuing the above example, as depicted in FIG. 3, the advertiser might select a geographic granularity of “metro area” to target populations in and around metropolitan areas based on collective data gathered for those respective areas.

The collective data is analyzed based on the selected geographic granularity and the selected target criteria received from the advertiser to determine geographic areas meeting those limitations, as indicated at a step 406. Again continuing the above example depicted in FIG. 3, the collective data is parsed, sorted, or otherwise examined to identify collective data associated with the selected geographic granularity, “metro area.” The collective data is further analyzed to determine metro areas that meet the target criteria, e.g. have a median age of women greater than or equal to 44, average household income less than $47,000, and an average snowfall greater than or equal to 20 inches.

Metro areas associated with collective data that meets the received criteria are identified and may be indicated to the advertiser, such as via the identified-geographic-areas field 310 of FIG. 3. In an embodiment, the identified geographic areas are not provided to the advertiser. It is to be understood that the application of the target criteria and geographic granularity to the collective data to determine the geographic areas can be completed in a variety of ways, methods, and orders of steps. All such variations are understood as being within the scope of embodiments of the invention described herein.

In an embodiment, the target criteria are associated with collective data that is updated in real-time, periodically, or upon request. As such, the identification of the geographic areas that meet the target criteria may be updated in real-time, periodically, or upon demand to ensure proper identification of the geographic areas. For example, the target criteria might require a current temperature or a forecasted high temperature in a geographic area to be greater than 32° F. or 0° C. As such, the identified geographic areas would likely change from day to day or even minute to minute. Thus, the identification of the geographic areas can be updated as desired.

To complete the campaign and advertisement setup one or more keywords to be associated with the advertisement are received at a step 408 and, a bid for providing the advertisement for presentation to a user is received at a step 410. The keywords are associated with the advertisement or campaign and are employed to indicate search queries for which the advertisements should be provided, as is known in the art.

The bid for providing the advertisement indicates an amount of money or a payment that the advertiser agrees to pay for provision of the advertisement for presentation to a user. The bid may be specific to an individual advertisement, multiple advertisements, or to the campaign. Further, the bid might apply only to provision of the advertisement to users identified as being located within one of the geographic areas identified above. In an embodiment, a second bid is received for provision of the advertisement to users that supply one or more of the keywords but that are not located in one of the geographic areas. The bid and bidding process is configured in any desired manner known in the art. For example, bidding can involve an auction between the advertiser and other advertisers.

With additional reference now to FIG. 4A, the provision of an advertisement to a user of a search engine subsequent to an advertisement campaign setup, as described above, is described in accordance with an embodiment of the invention. At a step 412 a search query is received from a user by a search engine. The search query includes one or more keywords that are associated with an advertisement campaign.

The geographic location of the user is also determined at a step 414. The user's geographic location is identified in any available manner such as by IP (Internet Protocol) address supplied by the user's computing device, by querying the user's computing device for location coordinates, e.g. longitude and latitude coordinates from a GPS (geographic positioning system) unit in a mobile device used to submit the query, or by provided user-specific data, among others.

At a step 416, it is determined that the user's geographic location lies within one of the geographic areas associated with an advertisement/campaign that is also associated with one or more of the keywords supplied by the user. At a step, 418, the advertisement is provided for presentation to the user. And at a step 420 the advertiser is debited the bid amount for provision of the advertisement to the user.

Accordingly, the advertisement is provided for presentation to a user based on the user's identified geographic location and the keywords provided by the user. No user-specific data associated with the user, except the user's geographic location, is employed in the identification of the advertisement and provision thereof to the user. The advertisement is identified for provision to the user based on the user being in a pre-identified geographic location. The collective data for the population, of which the user is a part, and the geographic area in which the user is located are employed to identify the advertisement for provision to users in the geographic area generally; the advertisement is not specifically targeted to any one individual user. In an embodiment, available user-specific data is used in addition to the collective data and geographic location of the user to identify advertisements to be provided for presentation to the user.

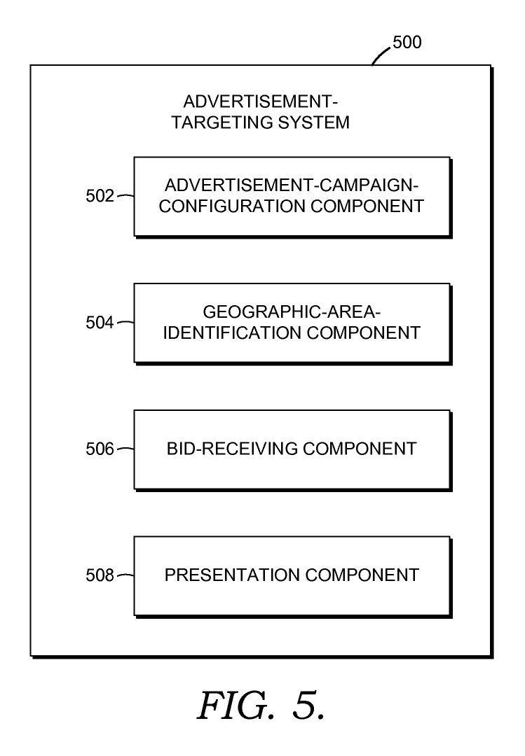

With reference now to FIG. 5, an advertisement-targeting system 500 for targeting advertisements presented in a search engine results page based on collective data and a user's location is described in accordance with an embodiment of the invention. The system 500 includes an advertisement-campaign-configuration component 502, a geographic-area-identification component 504, and a bid-receiving component 506.

The advertisement-campaign-configuration component 502 is configured to receive any desired data from an advertiser that is necessary or useable for account creation, advertisement campaign creation and setup, and payment of debts on an account, among others. In an embodiment, the system 500 optionally includes a presentation component 508 that provides a user interface for use by the advertiser in supplying account, campaign, and payment information.

The component 502 receives from an advertiser, a selection of target criteria for an advertisement, a group of advertisements, or an advertisement campaign. The component 502 may also receive indications of values or ranges of values of collective data that satisfy a respective target criterion. In addition, a level of geographic granularity is selected by an advertiser and received by the component 502. One or more keywords associated with an advertisement might also be received by the component 502.

The geographic-area-identification component 504 identifies one or more geographic areas based on the geographic granularity or geographic subdivision indicated by the advertiser and based on collective data for the respective geographic areas. Geographic areas having collective data meeting the target criteria are identified and may be presented to the advertiser or retained internally.

The bid-receiving component 506 receives a bid from the advertiser indicating an amount to be paid for provision of the advertisement for presentation to a user. The bid may be specified for various characteristics of provision of the advertisement. For example, the bid might be higher for provision of the advertisement to a user in a geographic area identified by the geographic-area-identification component 504 and less for provision to a user that is not located in such an area. Additionally, the bid might be different based on various other characteristics, such as, for example, the time of day, the type of advertisement media, e.g. text, image, or video, the placement location of the advertisement on a search engine results page, or the matching keywords, among others.

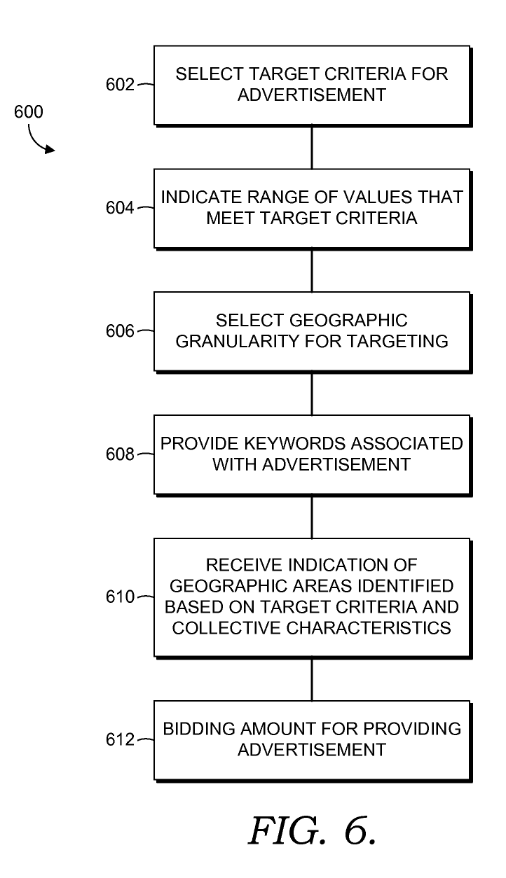

Turning now to FIG. 6, a method 600 for targeting advertisements presented in a search engine results page based on collective data and a user's identified location is described in accordance with an embodiment of the invention. At a step 602 an advertiser selects one or more target criteria for an advertisement. The advertiser indicates a value or range of values that meet the target criteria, at a step 604. The advertiser also selects a geographic granularity for targeting of the advertisement, at a step 606 and supplies one or more keywords to be associated with the advertisement, at a step 608.

At a step 610, an indication of one or more geographic areas that have been identified based on the geographic granularity, collective data for geographic areas, and the target criteria is received by the advertiser. In an embodiment, the one or more identified geographic areas are presented in a selectable list. The advertiser may provide a selection of one or more of the identified geographic areas that they wish to target for advertisement. The selection may indicate that the advertisement is only to be provided for presentation to users located in the selected geographic areas or that the bid for provision to users in the selected areas is to be different. The advertiser might also select all of the identified geographic areas for provision of the advertisement. In another embodiment, the advertiser only receives an indication that at least one geographic area has been identified. In an embodiment, the advertiser is not informed of the identity of the identified geographic areas.

In an embodiment, an estimated reach value is received by the advertiser. The reach value provides an estimated percentage, ratio, or other quantity of a population that meet the target criteria. The reach value is calculated in any desired way that provides an estimate of a portion of the population that meet selected target criteria. The population is that of all identified geographic areas meeting the target criteria or is only the population of a selected one or more of the identified geographic areas. For example, as depicted at 316 in FIG. 3, about 0.08% of the population in the identified geographic areas is estimated to fall within the selected target criteria 308 based on collective data for those geographic areas.

In an embodiment, the estimated reach value is recalculated each time the advertiser selects different/additional target criteria or values therefor. As such, the advertiser can utilize the reach value to determine target criteria that might increase the likelihood that an advertisement campaign will reach the desired users.

With continued reference to FIG. 6, an advertiser bids an amount for providing an advertisement for presentation to users that provide one or more of the keywords and that are identified as being located in one of the identified geographic areas. As described previously, the bid may be variable based on the user's location, keywords received, time of day, type of advertisement media, and user device, among a variety of other characteristics.

Embodiments of the invention enable advertisers to target users based on available data for the populations and geographic areas in which they are located. Several embodiments of the invention are described below to provide insight into a number of instances in which such targeting can be used. In a first example, a clothing distributor specializing in an extensive line of coats generates an advertisement campaign with multiple advertisements and uses the keyword “coats.” A first group of the advertisements is for heavy coats and are geared toward users in areas having cold winters with high snowfall amounts while a second group is for lighter jackets and are aimed at users in areas with milder winters with moderate rainfall. The distributor selects target criteria for the first group including average temperatures for November-February that are less than 32° F. and average annual snowfall greater than 30 inches. For the second group the distributor selects target criteria including average annual low temperatures between 32 and 65° F. and annual rainfall amounts between 25 and 50 inches.

Accordingly, geographic areas are identified based on the target criteria for each group. Thus, users executing a search query on a search engine using the keyword “coats” and that are located in a geographic area that has average temperatures and snowfall amounts meeting the target criteria for the first group will receive the appropriate advertisements from the first group Likewise users located in geographic areas that have collective data that meet the target criteria for the second group will receive advertisements from the second group. Thereby, the distributor is able to have its advertisements provided to appropriate or desired groups of users based on the collective data for their respective geographic locations.

In another example, a pharmaceutical company that would like to promote a new cholesterol drug to physicians and to people over 65 years old. The company develops a first advertisement directed toward physicians and a second advertisement directed toward potential customers over 65 years old. The keyword “cholesterol” is to be employed for both advertisements. The company sets up a first set of target criteria for the first advertisement that include criteria, such as ratio of doctors to citizens greater than 1:1000, average annual income greater than $200,000, and average household size greater than 2000 square feet, in order to target geographic areas that are most likely to have doctors therein. For the second advertisement, the company selects target criteria including average age greater than 40 and percentage of population that is retired is greater than 30% to target geographic areas that include potential customers of the company.

Accordingly, the company bids an increases amount for their first or second advertisements being provided for presentation to users in the identified respective geographic areas. And the company bids a lesser amount for presentation of their second advertisement in any other geographic areas from which a search query is received containing the keyword “cholesterol.” Thereby, the company can increase its likelihood of reaching potential those who potentially have interest in the advertisement and by increasing their bid in those geographic areas can increase the likelihood of the advertisements being presented over other lower bid advertisements.

In yet another example, a jewelry store associates advertisements for anniversary gifts and jewelry with target criteria aimed at geographic areas with populations having an average age greater than 30 and average individual income greater than $50,000 per year. The jewelry store also associates advertisements for engagement rings with geographic areas having younger, college age populations.

Similarly, a specialty food store that specializes in authentic Mexican and Latin cuisine provides an increased bid amount for provision of its advertisement for presentation to users in geographic areas in which the Hispanic population is greater than 30 percent. Or a home security company provides an increased bid amount for provision of its advertisement in geographic areas in which the property crimes rate is above the national average and the average annual household income is between $30,000 and $70,000.

In another example, a manufacturer of a new electric car creates an advertisement campaign utilizing the keyword “car.” The car is initially only going to be sold in specific cities on the west coast of the United States and for a cost of about $40,000. Also, the driving range of the car is about 50 miles round trip. So the manufacture includes target criteria such as, average annual income greater than $65,000, average commute distance less than 25 miles one way. The manufacturer also specifies a geographic granularity of “metro area.” A number of metro areas are identified and presented to the manufacturer in a selectable list. The manufacturer selects from the list only those cities in which the vehicle will be sold, or that are nearby, and provides a bid for provision of the advertisement for search queries executed from those geographic areas.

In yet another example, a politician running for federal office wishes to target a wide variety of citizens on a wide variety of topics. However, the politician believes that only certain of those topics apply or appeal to certain groups of the citizens. Accordingly, the politician sets up an advertisement campaign with a multitude of advertisements each with its own target criteria. A geographic granularity of voting precinct is selected. As such, provision of individual advertisements and their subject matter is tailored to geographic areas or voting precincts having populations most likely to be influenced by the advertisements.

Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. Computer-readable media having computer-executable instructions embodied thereon that, when executed, perform a method for targeting advertisements to a user of a search engine based on collective data, the method comprising:
receiving a selection of one or more target criteria for an advertisement;
receiving a selection of a geographic granularity for advertisement targeting;
determining via a computing device having a processor, a geographic area in which collective data associated with one or more of a population of users and the geographic area correlate with the target criteria, the geographic area being identified with respect to the geographic granularity; and
receiving a bid for an amount to be paid for providing the advertisement for presentation to a user of a search engine, the user being located within the geographic area.

2. The computer-readable media of claim 1, further comprising:
receiving one or more keywords to be associated with the advertisement.

3. The computer-readable media of claim 2, further comprising:
receiving a search query from a user that includes at least one of the one or more keywords;
determining a geographic location of the user;
determining that the geographic location lies within the geographic area;
providing the advertisement for presentation to the user on a search engine results page; and
debiting an advertiser the bid amount.

4. The computer-readable media of claim 1, wherein the collective data comprises one or more of demographic data, statistical data, census data, publicly available commercial data, privately held commercial data for the population of users, and data associated with the geographic area or conditions in the geographic area.

5. The computer-readable media of claim 1, wherein the collective data includes dynamically generated data that is updated in real-time, periodically, or upon request.

6. The computer-readable media of claim 1, wherein the geographic granularity defines the geographic area at the level of countries, regions, states, counties, parishes, townships, cities, zip codes, or census tracts.

7. The computer-readable media of claim 1, wherein determining the geographic area further comprises:
providing a list that includes the geographic area from which an advertiser selects one or more target area,
wherein the bid for providing the advertisement for presentation to a user is greater when the user is identified as being located within the one or more target area than when the user is identified as not being located within the one or more target area.

8. The computer-readable media of claim 1, further comprising:
receiving an indication of a range of values that satisfy one or more of the target criteria.

9. The computer-readable media of claim 1, further comprising:
calculating a reach value that indicates a percentage of users in the geographic area that meet the target criteria based at least in part on the collective data.

10. A system for targeting advertisements presented in a search engine results page based on collective data and a user's location, the system comprising:
an advertisement-campaign-configuration component configured to receive a selection of one or more target criteria to be associated with an advertisement and to receive a selection of a level of geographic granularity upon which targeting of the advertisement is to be based, the target criteria indicating characteristics of one or more of a user population, a geographic location, or data associated with the user population or geographic location;
a geographic-area-identification component executed by a computing device having a processor and is configured to identify one or more geographic areas for which collective data correlates with the target criteria, the geographic area being identified with respect to the geographic granularity, the collective data describing characteristics of, or associated with, one or more of a user population in the geographic area and the geographic area, and the collective data including only non-user-specific data; and
a bid-receiving component configured to receive a bid indicating an amount to be paid for providing the advertisement for presentation to a user that is identified as being located within the one or more geographic areas.

11. The system of claim 10, further comprising:
a presentation component configured to provide a user interface for presentation to an advertiser by which selection of the one or more target criteria, the geographic granularity, and the bid are received.

12. The system of claim 10, wherein the collective data is statistical data for a user population in the geographic area.

13. The system of claim 10, wherein the collective data includes dynamically generated data that is obtained in real-time, periodically, or on demand.

14. The system of claim 10, wherein the collective data includes privately owned data.

15. The system of claim 10, wherein the advertisement-campaign-configuration component is further configured to receive one or more keywords associated with the advertisement, and wherein the advertisement is provided for presentation to the user that is located within the one or more geographic areas and that provides one or more of the keywords in a search query to the search engine.

16. The system of claim 10, wherein the bid is greater for providing the advertisement for presentation to the user that is located within the one or more geographic areas than when the user is not located within the one or more geographic areas.

17. The system of claim 10, wherein the user's location is identified based on an identified location of a mobile device employed by the user to enter a search query to a search engine.

18. A method for targeting advertisements presented in a search engine results page based on collective data and a user's identified location, the method comprising:
selecting, by an advertiser via a user interface presented by a first computing device having a processor, one or more target criteria to be associated with an advertisement;
selecting a geographic granularity for targeting of the advertisement;
providing one or more keywords associated with the advertisement;
receiving an indication of a geographic area associated with collective data that meets the target criteria, the geographic area being identified by a second computing device having a processor based on collective characteristics of one or more of the geographic area and a population of users in the geographical area, the collective characteristics including only non-user-specific information, and the geographic area being indicated at the selected geographic granularity level; and
bidding an amount to be paid for providing an advertisement to be presented to a user that is located within the geographic area and that provides at least one of the one or more keywords to a search engine, the advertisement being presented on a search engine results page.

19. The method of claim 18, wherein selecting one or more target criteria to be associated with an advertisement further comprises:
indicating a range of values of collective data that meet the target criteria.

20. The method of claim 18, wherein a plurality of geographic areas associated with collective data that meet the target criteria are indicated, and further comprising:
selecting one or more of the plurality of geographic areas, now selected geographic areas;
bidding an increased amount for providing the advertisement for presentation to users located within the selected geographic areas.
